(19) United States
(12) Patent Application Publication
(10) Pub. No.: US 2008/0270158 A1
(43) Pub. Date: Oct. 30, 2008

(54) Method and apparatus for geo-spatial and social relationship analysis

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/799,282

(22) Filed: Apr. 30, 2007

(51) Int. Cl. G06Q 99/00

(52) U.S. Cl. 705/1

(57) ABSTRACT

A method and apparatus for geo-spatial and social relationship analysis are disclosed. In one embodiment, a method of contacting a target member of a community includes obtaining a target location of the member, obtaining a social path to the target member, determining an association between a node location of at least one node of the social path and the target location of the target member, generating a geo-spatial index that determines a geographic proximity each node is from the target member, and communicating with the target member using the at least one node of the social path based on the geographic proximity between each node and the target member. The method may include establishing a social link with the target member using the at least one node.

### FIELD OF TECHNOLOGY

This disclosure relates generally to the technical fields of communications and, in one example embodiment, to a method and apparatus for geo-spatial and social relationship analysis.

### BACKGROUND

A social network may correspond to a social structure made of nodes, which may include individuals and/or organizations, and links between the nodes. The links may correspond to varying degrees of social familiarity, from those of casual acquaintances to close familial bonds. The social networks may be tracked and maintained on web-based applications, enabling friends, business partners, and/or other individuals to connect with one another using a variety of tools.

In online social networks, users may create profiles that include information such as a name, an address, a contact information, a picture, and/or other personal information. For example, a friend-based social network may allow the users to upload photos to their profiles, while a business social network may allow the users to include work experience, education, and/or references on their profiles.

Connections, or links, may also be made between the users in the online social network. For example, two users on the friend-based social network may become “friends” if both the users approve the connection. Similarly, a business connection may be made on the business social network if two users have worked together and are interested in collaborating on future work. The connections, or links, between the users form the basis of the online social networks and social network theory in general.

Several hypotheses exist for connectedness of the social network. A “small world phenomenon” postulates that a searching member of the social network may be connected to another member using a relatively short path of links between the members. A “six degrees of separation” hypothesis suggests that each member of the social network is no more than six links away from another member. However, neither the “small world phenomenon” nor the “six degrees of separation” hypotheses consider geo-spatial proximity of the members with each other. Instead, both hypotheses model links of currently known social familiarity between the members of the social network (e.g., a second degree member may live next door to a sixth degree away member). As a result, it may take a long time for the member to reach a connection that is four, five, or six degrees away from him.

The searching member may have to send a request to and get permission from each one of the members connected one, two, and three degrees away to reach a member who is four, five, and/or six degrees away from the searching member. Sometimes, the members who are one, two, and/or three degrees away from the searching member may not use the social network often and/or may be reluctant to forward the request to the next member in the chain. It may be possible that one of the users who is one, two, or three degrees away is a next door neighbor of a target user (i.e., physically lives next door to the person six degrees away, who the user wants to reach). However, the social network may still require the searching member to go through six degrees of separation. In other cases, a person that the searching member seeks to connect with may not be a member of the social network at all. In such situations, it may be difficult for the searching member to contact the person through the social network.

### SUMMARY

A method and apparatus for geo-spatial and social relationship analysis are disclosed. In one aspect, a method of contacting a target member of a community includes obtaining a target location of the target member (e.g., a person, a business, and/or an organization), obtaining a social path to the target member, determining an association between a node location of at least one node (e.g., a member of the community) of the social path and the target location of the target member, generating a geo-spatial index that determines a geographic proximity (e.g., associated with a location of the target member) each node is from the target member, and communicating with the target member using the at least one node of the social path based on the geographic proximity between each node and the target member.

The method may further include establishing a social link with the target member using the at least one node. The method may include obtaining a global positioning system (GPS) coordinate of the at least one node, and generating the geo-spatial index using the GPS coordinate. The method may also include displaying the geographic proximity on a geo-spatial map.

In another aspect, a social network includes a geo-spatial repository consisting of a plurality of locations, a member repository consisting of a plurality of members (e.g., the plurality of members may include at least one selected from a group consisting of a person, a business, and/or an organization), a social relationship analysis module configured to determine a social path (e.g., the social path may include a plurality of nodes from the member repository and a plurality of links between the plurality of nodes) between a first of the plurality of members and a second of the plurality of members, and a geo-spatial relationship analysis module configured to determine a geo-spatial link (e.g., the geo-spatial link may include a proximity between a first of the plurality of locations associated with the one of the plurality of nodes and a second of the plurality of locations associated with the second of the plurality of members) between one of the plurality of nodes and the second of the plurality of members.

The social network may further include a relationship management module configured to determine a shortest path (e.g., determined using the social path and the geo-spatial link) between the first of the plurality of members and the second of the plurality of members. In addition, the relationship management module may be configured to establish a social link between the first of the plurality of members and the second of the plurality of members. The social network may include a member management module configured to obtain member data (e.g., a location) associated with each of the plurality of members. In addition, the location may be obtained using a global positioning system (GPS).

The social network may further include a user interface consisting of a user update module configured to obtain changes to the member repository, a member search module configured to obtain a search result for the second of the plurality of members based on a query by the first of the plurality of members, a relationship display module configured to display the one or more links and the geo-spatial link, and a geo-spatial tracker configured to display and update the geo-spatial link on a geo-spatial map.

In yet another aspect, a computer readable medium containing software instructions embodied therein for causing a computer system to perform a method of contacting an nth degree away member (e.g., a person, a business, and/or an organization) of a community includes determining a location of the nth degree away member, obtaining a social path to the nth degree away member, determining a geo-spatial association between a node (e.g., a member of the community) of the social path and the location, and contacting the member using the node of the social path based on the geo-spatial association.

The method of the computer readable medium may include establishing a social link with the nth degree away member using the node. The method of the computer readable medium may also include obtaining a global positioning system (GPS) coordinate of the at least one node, and generating a geo-spatial index using the GPS coordinate. In addition, the method of the computer readable medium may include displaying the geographic proximity on a geo-spatial map.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a social network communicating with members of a community, according to one embodiment.

FIG. 2 is a schematic view of generating a geo-spatial index using a GPS coordinate, according to one embodiment.

FIG. 3 is a user interface view of the social network of FIG. 1, according to one embodiment.

FIG. 4 is a diagrammatic representation of a social link, according to one embodiment.

FIG. 5A is a block diagram representation displaying information associated with a person, according to one embodiment.

FIG. 5B is a block diagram representation displaying information associated with an organization, according to one embodiment.

FIG. 5C is a block diagram representation displaying information associated with a business, according to one embodiment.

FIG. 6 is a flowchart for obtaining geo-spatial links associated with a member, according to one embodiment.

FIG. 7 is a flow chart for contacting a target member using at least one node, according to one embodiment.

FIG. 8 is a diagrammatic system view of a data processing system in which any of the embodiments disclosed herein may be performed, according to one embodiment.

FIG. 9 is a network diagram of the social network of FIG. 1, according to one embodiment.

FIG. 10 is a user interface view of the member search module of FIG. 3, according to one embodiment.

FIG. 11 is an nth degree separation view, according to one embodiment.

FIG. 12 is a geo-spatial map view 1200 of the members of the social network of FIG. 1, according to one embodiment.

FIG. 13A is a process flow of contacting the target member of the community, according to one embodiment.

FIG. 13B is a continuation of the process flow of FIG. 13A, showing additional processes, according to one embodiment.

### Other features of the present embodiments will be apparent from the accompanying drawings and from the detailed description that follows.

### DETAILED DESCRIPTION

A method and apparatus for geo-spatial and social relationship analysis are disclosed. In the following description, for the purposes of explanation, numerous specific details are set forth in order to provide a thorough understanding of the various embodiments. It will be evident, however to one skilled in the art that the various embodiments may be practiced without these specific details.

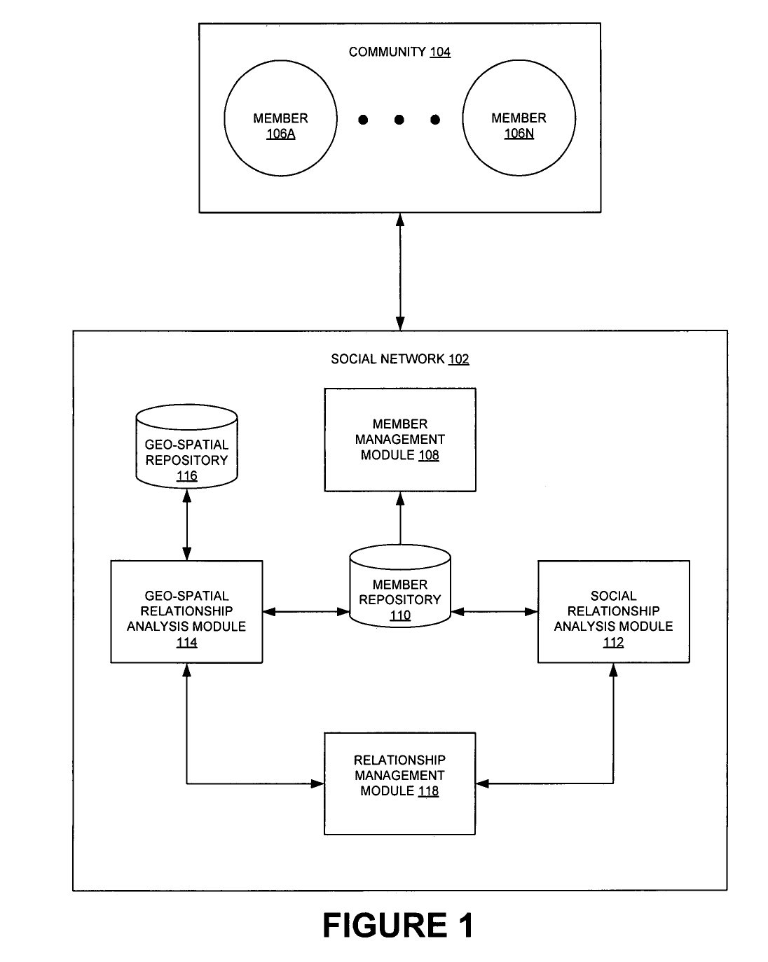

In one embodiment, a method of contacting a target member of a community (e.g., the members 106A-N of the community 104 of FIG. 1) includes obtaining a target location of the target member 106, obtaining a social path (e.g., using the social relationship analysis module 112 of FIG. 1) to the target member 106, determining an association between a node location of a node of the social path and/or the target location of the target member 106, generating a geo-spatial index (e.g., using the geo-spatial relationship analysis module 114 of FIG. 1) that determines a geographic proximity each node is from the target member 106, and communicating with the target member 106 using the node of the social path based on the geographic proximity between each node and the target member 106.

In another embodiment, a social network (e.g., the social network 102 of FIG. 1) includes a geo-spatial repository (e.g., the geo-spatial repository 116 of FIG. 1) consisting of any number of locations, a member repository (e.g., the member repository 110 of FIG. 1) consisting of any number of members (e.g., the members 106A-N of FIG. 1), a social relationship analysis module (e.g., the social relationship analysis module 112 of FIG. 1) configured to determine a social path (e.g., the social path may include a set of nodes from the member repository and a set of links between the plurality of nodes) between a first member 106 and a second member 106, and a geo-spatial relationship analysis module (e.g., the geo-spatial relationship analysis module 114 of FIG. 1) configured to determine a geo-spatial link (e.g., the geo-spatial link may include a proximity between a first location associated with the one of the nodes and a second location associated with the second member 106) between the node and the second member 106.

In yet another embodiment, a computer readable medium containing software instructions embodied therein for causing a computer system to perform a method of contacting an nth degree away member 106 of a community (e.g., the community 104 of FIG. 1) includes determining a location of the nth degree away member 106, obtaining a social path (e.g., using the social relationship analysis module 112 of FIG. 1) to the nth degree away member 106, determining a geo-spatial association between a node of the social path and the location, and contacting the member 106 using the node of the social path (e.g., based on the geo-spatial association).

FIG. 1 is a system view of a social network 102 communicating with members 106A-N of a community 104, according to one embodiment. Particularly, FIG. 1 illustrates the social network 102, the community 104, the members 106A-N, a member management module 108, a member repository 110, a social relationship analysis module 112, a geo-spatial relationship analysis module 114, a geo-spatial repository 116, and a relationship management module 118, according to one embodiment.

The social network 102 may be a social structure formed by the members 106A-N associated with the community 104. The social structure may include nodes, which include the members 106A-N, and social links, which represent relationships between the members 106A-N. For example, the social links may include personal relationships (e.g., family, friends, etc.) and professional relationships (e.g., coworkers, business associates, clients, etc.). The community 104 may refer to a group (e.g., sociological group) of members 106A-N associated with specific geographic locations. Each member 106 may be a person, a business, and/or an organization associated with the specific geographic location in the community 104. The member management module 108 may be configured to obtain member 106 data (e.g. a specified geographic location) associated with the members 106A-N. The member repository 110 may be a database containing profile information (e.g., names, addresses, professions, etc.) associated with the members 106A-N.

The social relationship analysis module 112 may determine a social path between a first member 106 associated with a location and a target member 106 associated with another location in the social network 102. The social path may include a set of nodes and social links between the first member 106 and the target member 106. For example, multiple social paths may exist between the first member 106 and the target member 106. As a result, the social relationship analysis module 112 may determine the most direct social path between the first member 106 and the target member 106.

In one example embodiment, the first member 106 and the target member 106 may have two social paths between them, one with two nodes, and one with four nodes. As a result, the target member 106 may be three degrees of separation from the first member 106 using the path with two nodes, or the target member 106 may be five degrees of separation from the first member 106 using the path with four nodes. The social relationship analysis module 112 may then select the path with two nodes as the social path from the first member 106 to the target member 106.

The geo-spatial relationship analysis module 114 may determine a geo-spatial link (e.g., a geographic proximity) between one of the nodes (e.g., the members 106A-N in the community 104) and the second member 106 (e.g., the target member 106) in the social network 102. In one example embodiment, the geo-spatial link may shorten the social path between two members 106 (e.g., the members 106A-N of FIG. 1) by using the geo-spatial link in lieu of one or more social links in the social path. The geo-spatial repository 116 may be a database containing the location information associated with the members 106A-N of the community 104. The relationship management module 118 may determine the shortest path (e.g., using the social path and the geo-spatial link) between the first member 106 and the target member 106.

In the example embodiment illustrated in FIG. 1, the members 106A-N associated with the community 104 communicate with each other through the social network 102. For example, the members 106 A-N of the social network 102 may communicate with one another using messages, instant messages, emails, voice calls, etc. (e.g., physical and/or electronic communication using computers over a network, portable communication devices, etc.) The social network 102 includes the member management module 108, the member repository 110, the social relationship analysis module 112, the geo-spatial relationship analysis module 114, the geo-spatial repository 116 and the relationship management module 118 interacting with each other, according to one embodiment.

A target location of the target member 106 (e.g., a person, a business, and/or an organization) and/or the social path to the target member may be obtained (e.g., using the social relationship analysis module 112 of FIG. 1). An association between a node location of a node (e.g., a member of the community 104) of the social path and the target location of the target member 106 may be determined. A geo-spatial index that determines a geographic proximity (e.g., associated with the location of the target member 106) of each node from the target member 106 may be generated (e.g., using the geo-spatial relationship analysis module 114 of FIG. 1). The target member 106 may be communicated with using the node of the social path based on the geographic proximity between each node and the target member 106.

The geo-spatial repository 116 may include any number of locations. The member repository 110 may include the members 106A-N. The social relationship analysis module 112 may be configured to determine a social path (e.g., the social path may include nodes from the member repository 110 and links between the nodes) between any two of the members 106A-N.

The geo-spatial relationship analysis module 114 may be configured to determine a geo-spatial link (e.g., the geo-spatial link may include a proximity between a first of the set of locations associated with the node and a second of the set of locations associated with the members 106A-N) between one of the nodes and the second member 106.

The relationship management module 118 may be configured to determine the shortest path (e.g., using the social path and the geo-spatial link) between the first member 106 and the second member 106. The shortest path may include one or more social links and a geo-spatial link between the members 106A-N (e.g., the first member 106 and the second member 106). The member management module 108 may be configured to obtain member data (e.g., may contain a location obtained using a global positioning system (GPS)) associated with each of the members.

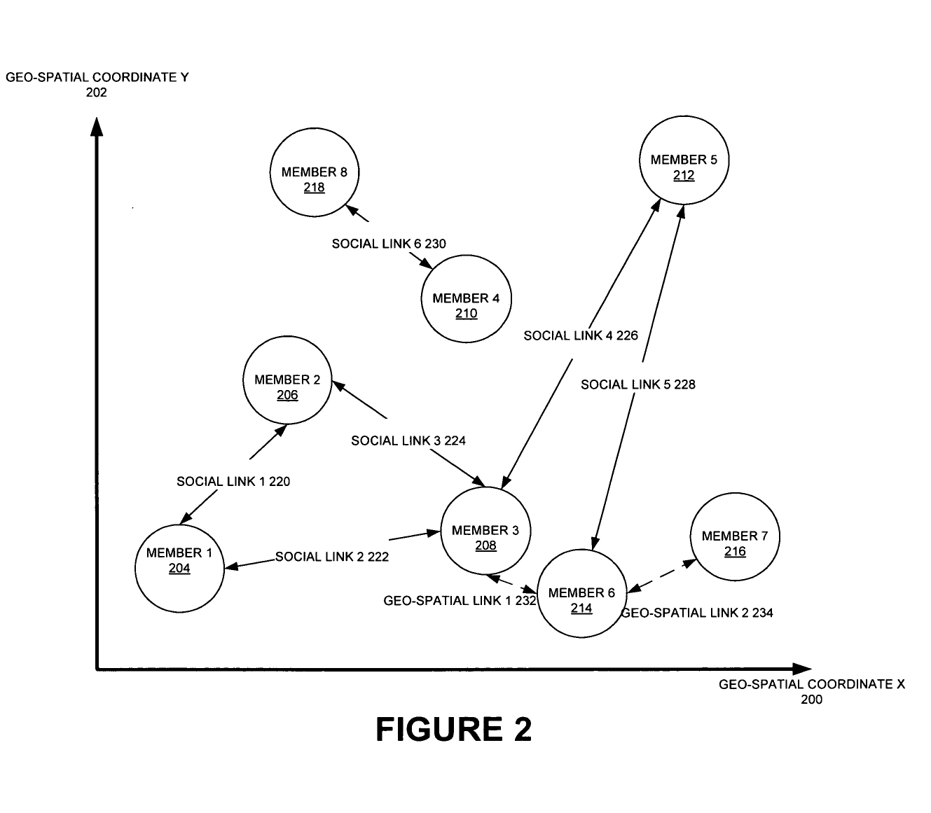

FIG. 2 is a schematic view of generating the geo-spatial index using a GPS coordinate, according to one embodiment. Particularly, FIG. 2 illustrates geo-spatial coordinates (e.g., the geo-spatial coordinate X 200 and the geo-spatial coordinate Y 202), member(s) (e.g., the member 1 204, the member 2 206, the member 3 208, the member 4 210, the member 5 212, the member 6 214, the member 7 216 and the member 8 218), social link(s) (e.g., the social link 1 220, the social link 2 222, the social link 3 224, the social link 4 226, the social link 5 228 and the social link 6 230), and geo-spatial link(s) (e.g., the geo-spatial link 1 232 and the geo-spatial link 2 234), according to one embodiment.

The geo-spatial coordinates may be an ordered pair used to determine the locations associated with the members (e.g., the members 106A-N illustrated in FIG. 1) on a two-dimensional plane and/or in a three-dimensional space. The member(s) illustrated in FIG. 2 may be persons, businesses and/or organizations associated with the specific geographic location. The social link may be a link or connection established between any two members (e.g., the members 106 of FIG. 1) of the community 104. The geo-spatial link may be a shortest path between the first node and the second member 106 (e.g., the member 1 204, the member 2 206, the member 3 208, the member 4 210, the member 5 212, the member 6 214, the member 7 216 and the member 8 218 illustrated in FIG. 2).

In the example embodiment illustrated in FIG. 2, the location associated with the members of the community 104 is determined using the geo-spatial coordinate X 200 and the geo-spatial coordinate Y 202. The social path is formed between the member 1 204 (e.g., the first member) and the member 7 216 (e.g., the target member) using the nodes (e.g., the member 2 206, the member 3 208, the member 5 212, the member 6 214) and the links (e.g., the social links and the geo-spatial links) between the nodes. In one example embodiment, the members associated with the social path are represented as nodes in a graph. The geo-spatial links are formed between the member 3 208 and the member 6 214, and between the member 6 214 and the member 7 216. The shortest path between the member 1 204 and the member 7 216 may be determined using the social links and the geo-spatial links. The member 1 204 communicates with the target member 7 216 using the shortest path formed through the nodes (e.g., the member 3 208 and the member 6 214) and the links (e.g., the social link 2 222, the geo-spatial link 1 232 and the geo-spatial link 2 234).

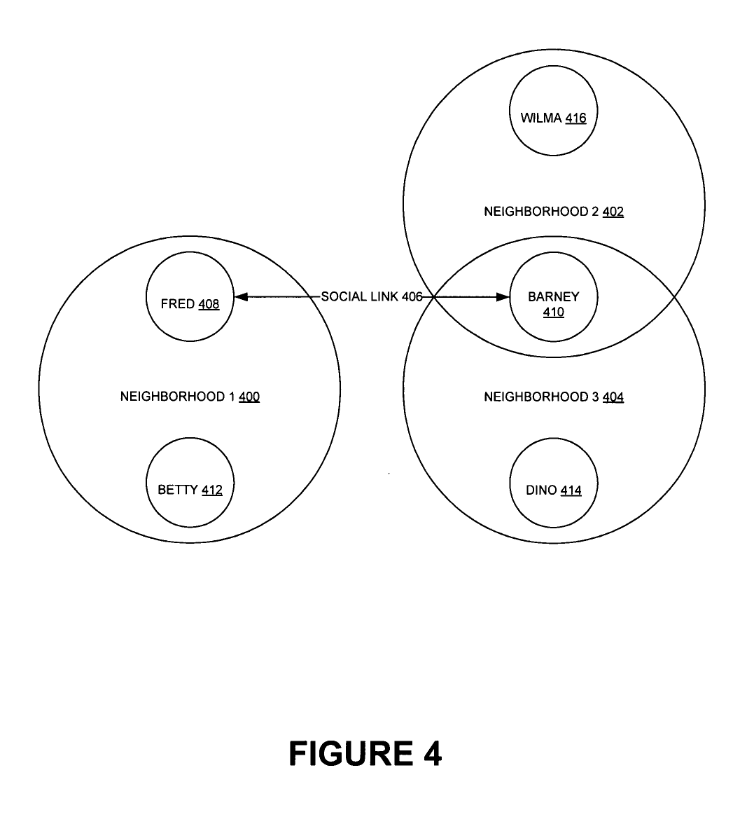

A social link (e.g., the social link 406 of FIG. 4) may be established with the target member using the node (e.g., using the relationship management module 118 of FIG. 1). The global positioning system (GPS) coordinate of the node may be obtained. The geo-spatial index may be generated using the GPS coordinate. The geographic proximity (e.g., may be associated with a location of the target member 106) may be displayed on a geo-spatial map. The geo-spatial link may include a proximity between a first of the set of locations associated with the one of the nodes and a second of the set of locations associated with the second member.

For example, member 1 204 may try to contact member 6 214. Member 1 204 may reach member 6 214 using one of two series of social links. Specifically, member 1 204 may use social link 1 220 to reach member 2 206, social link 3 224 to reach member 3 208, social link 4 226 to reach member 5 212, and social link 5 228 to reach member 6 214. Alternatively, member 1 204 may bypass member 2 206 entirely by using social link 2 222 to directly reach member 3 208. For example, the two paths outlined above include four and three degrees of separation between member 1 204 and member 6 214, respectively. However, as shown in FIG. 2, a geo-spatial link (e.g., geo-spatial link 1 232) exists between member 3 208 and member 6 214. As a result, member 1 204 may reach member 6 214 by using geo-spatial link 1 232 between member 3 206 and member 6 214. The geo-spatial link 1 232 may be based on the geographic proximity between member 3 206 and member 6 214. For example, member 3 208 and member 6 214 may be located within a certain distance of one another, or reside in a common neighborhood. Member 1 204 may then contact member 3 208 in order to reach member 6 214 based on the geographic proximity of member 3 208 to member 6 214.

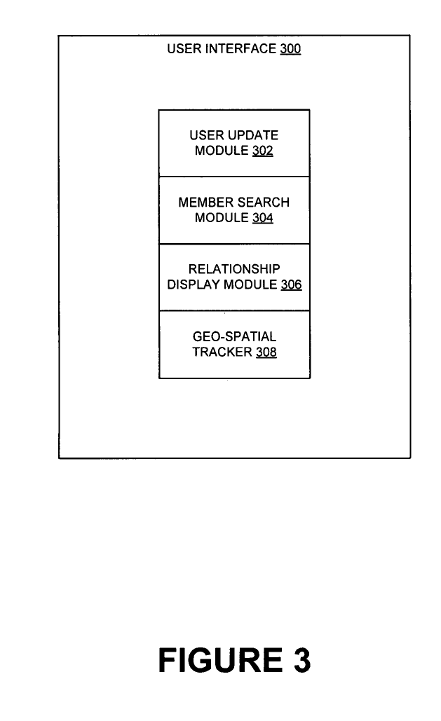

FIG. 3 is a user interface view 300 of the social network 102 of FIG. 1, according to one embodiment. Particularly, FIG. 3 illustrates a user update module 302, a member search module 304, a relationship display module 306, and a geo-spatial tracker 308, according to one embodiment.

The user update module 302 may be configured to obtain changes to the member repository (e.g., the member repository 110 of FIG. 1) corresponding to changes in information associated with the members of the social path (e.g., the members 106A-N of FIG. 1). For example, the user update module 302 may be used to change a user's name, address, telephone number, email address, marital status, profile picture, etc. The user update module 302 may also allow profiles to be added and/or deleted. The member search module 304 may search the location associated with the members 106A-N based on a query (e.g., a first name, a last name, a location, etc.) requested by the user and/or display the search result associated with the query. The relationship display module 306 may display one or more social links and any geo-spatial links between any two members 106A-N of the community. The relationship display module 306 may also allow one member 106 to contact another member 106 (e.g., using the social links and/or geo-spatial link). The geo-spatial tracker 308 may display and/or update the geo-spatial link on a geo-spatial map.

FIG. 4 is a diagrammatic representation of a social link, according to one embodiment. Particularly, FIG. 4 illustrates a neighborhood 1 400, a neighborhood 2 402, a neighborhood 3 404, a social link 406, member(s) 408, 410, 412, 414 and 416, according to one embodiment.

The neighborhood(s) (e.g., the neighborhood 1 400, 2 402 and 3 404) may correspond to a localized community (e.g., the community 104 of FIG. 1) located in a city, town, and/or suburb. The localized community may be defined using a radius around a location, and/or the localized community may correspond to a distinct area, such as a subdivision, district, etc. The neighborhood(s) may include members, residences, businesses, organizations, etc. The social link 406 may be a link or connection through which a member of one neighborhood (e.g., the member 408) communicates with a member of another neighborhood (e.g., the member 412).

The example embodiment illustrated in FIG. 4 displays a neighborhood 1 400, the neighborhood 2 402, and the neighborhood 3 404. The member 408 (e.g., Fred) and the member 412 (e.g., Betty) are located in the neighborhood 1 400. The member 416 (e.g., Wilma) is located in the neighborhood 2 402. The member 414 (e.g., Dino) is located in the neighborhood 3 404. The member 410 (e.g., Barney) is the common member to the neighborhoods 2 402 and 3 404. The member 408 (e.g., Fred) and the member 410 (e.g., Barney) are connected to each other through the social link 406.

For example, Fred 408 may want to contact Wilma 416. However, Wilma 416 may be more than a few social links away from Fred 408. As a result, Fred 408 may find contacting Wilma 416 through the social links alone difficult and time-consuming. However, Fred 408 has a social link 406 to Barney 410. Barney 410 is also located in the same neighborhood (e.g., the neighborhood 2 402) as Wilma 416. As a result, Fred 408 may ask Barney 410 to contact Wilma 416 on Fred's behalf, using Fred's social link 406 to Barney 410 and Barney 410's geographic proximity to Wilma 416. Similarly, Fred 408 may contact Dino 414 through Barney 410, and Barney 410 may contact Betty 412 through the social link 406 and Fred's geographic proximity to Betty 412 in the neighborhood 1 400. In one example embodiment, a user (e.g., Barney 410) may belong to more than one neighborhood (e.g., the neighborhood 2 402 and the neighborhood 3 404). As a result, that user may be geo-spatially linked to multiple other users, even if the other users are not geo-spatially linked to one another.

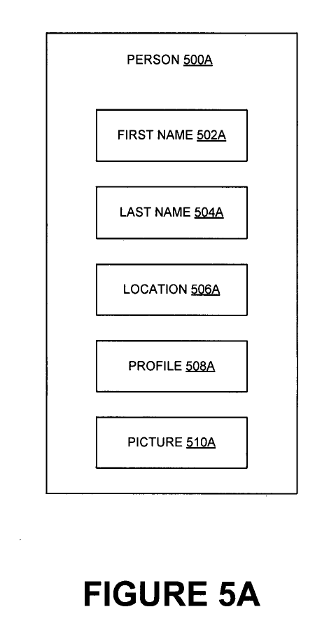

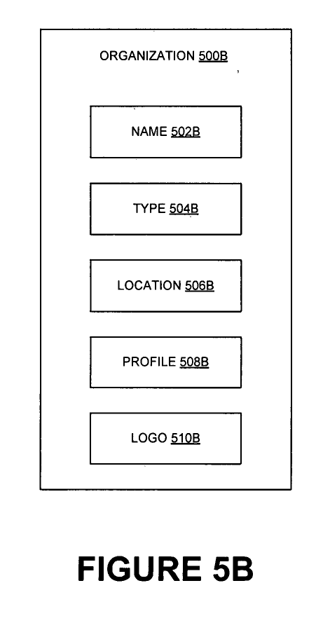

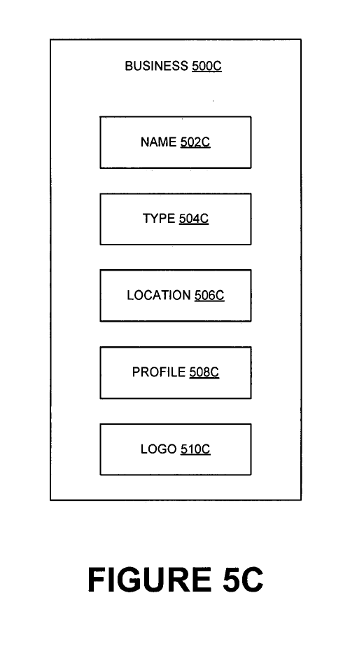

FIG. 5A is a block diagram representation displaying information associated with a person 500A (e.g., the member 106 illustrated in FIG. 1), according to one embodiment. In one or more embodiments, the information is associated with a person 500A in a social network, such as the social network 102 of FIG. 1. Particularly, FIG. 5 illustrates a first name block 502A, a last name block 504A, a location block 506A, a profile block 508A, and a picture block 510A, according to one embodiment.

The block diagram may display a first name in the first name block 502A, a last name in the last name block 504A, a location information in the location block 506A, profile details in the profile block 508A, and a photo in the picture block 510A associated with the person 500A (e.g., a member 106 of the community 104). The profile block 508A may display profile information (e.g., age, gender, profession, etc.) associated with the person 500A.

In the example embodiment illustrated in FIG. 5A, the block diagram representation shows various details (e.g., an address data, a content data, etc. stored in the member repository) associated with the target member 106. Other members 106 (e.g., the members 106A-N of FIG. 1) can search for the target member 106 (e.g., the person 500A) based on the first name, the last name, the location, the profile, and/or the picture information associated with the person 500A.

FIG. 5B is a block diagram representation displaying information associated with an organization 500B, according to one embodiment. In one example embodiment, the information is associated with an organization 500B in a social network, such as the social network 102 of FIG. 1. Particularly, FIG. 5B illustrates a name block 502B, a type block 504B, a location block 506B, a profile block 508B, and a logo block 510B, according to one embodiment.

The name block 502B may display the name of the organization 500B (e.g., the member 106 of FIG. 1). The type block 504B may represent the organization type (e.g., a political organization, an environmental organization, a non-profit organization, etc.) associated with the organization 500B. The location block 506B may display the address data (e.g., a city, a country, a state, a zip code, etc.) associated with the organization 500B. The profile block 508B may display additional information (e.g., number of employees, turnover rates, etc.) of the organization 500B. The logo block 510B may be a symbol (e.g., logo) of the organization 500B (e.g., an incorporated company, a non-profitable organization, etc).

In the example embodiment illustrated in FIG. 5B, the block diagram representation displays various details (e.g., address data, content data, etc. stored in the member repository 110) associated with the organization 500B. The other members can search for the target member 106 (e.g., the organization 500B) based on the name, the type, the location, the profile, and/or the logo associated with the organization 500B.

FIG. 5C is a block diagram representation displaying information associated with a business 500C (e.g., the member 106 of FIG. 1), according to one embodiment. In one example embodiment, the information is associated with a business 500C in a social network, such as the social network 102 of FIG. 1. Particularly, FIG. 5C illustrates a name block 502C, a type block 504C, a location block 506C, a profile block 508C and a logo block 510C, according to one embodiment.

The name block 502C may contain the name of the business 500C. The type block 504C may represent the business type (e.g., a restaurant, a professional services firm, a retail store, a grocery, etc.). The location block 506C may display address data (e.g., a city, a country, a state, a zip code, etc.) associated with the business 500C. The profile block 508C may display additional information on the business 500C. The logo block 510C may be a symbol representing the business 500C.

In the example embodiment illustrated in FIG. 5C, the block diagram representation displays various details (e.g., address data, content data, etc. stored in the member repository 110) associated with the business 500C. The other members 106A-N can search for the target member 106 (e.g., the business 500C) based on the name, the type, the location, the profile, and/or the logo associated with the business 500C.

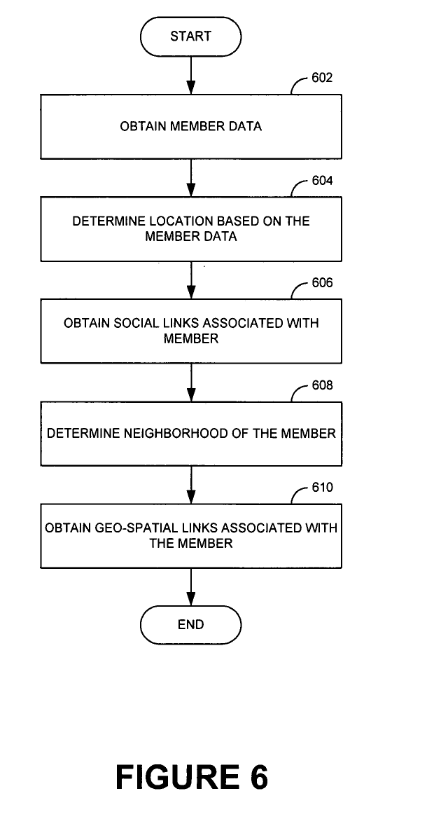

FIG. 6 is a flowchart for obtaining geo-spatial links associated with a member (e.g., the member 106 of FIG. 1), according to one embodiment. In operation 602, member data is obtained from a member repository (e.g. the member repository 110 of FIG. 1). The member data may include a name, an address, a telephone number, age, etc. The member data may also be inputted by the member 106 and/or obtained from another source, such as a public directory. In operation 604, a location of the member 106 is determined based on the member data. For example, the location may be determined using the member's address. In operation 606, social links associated with the member 106 (e.g., a target member 106) are obtained. The social links may include personal relationships, business relationships, and/or other ties between the member 106 and the other members 106 of a social network (e.g., the social network 102 of FIG. 1).

In operation 608, the neighborhood of the member 106 is determined using the member repository (e.g., the member repository 110 of FIG. 1) and the geo-spatial repository (e.g., the geo-spatial repository 116 of FIG. 1). The neighborhood may be based on a geographic radius around the member 106 and/or or the neighborhood may correspond to an actual area of the city, town, locality etc. that the member 106 is located in. In one example embodiment, the member 106's location may not always correspond to the member 106's residence. For example, the member 106's location may be established using a global positioning system (GPS) tracker located in the member 106's mobile phone. Regardless of the method of determining the member 106's location, the location may be used to determine the geo-spatial links associated with the member 106 as described in operation 610.

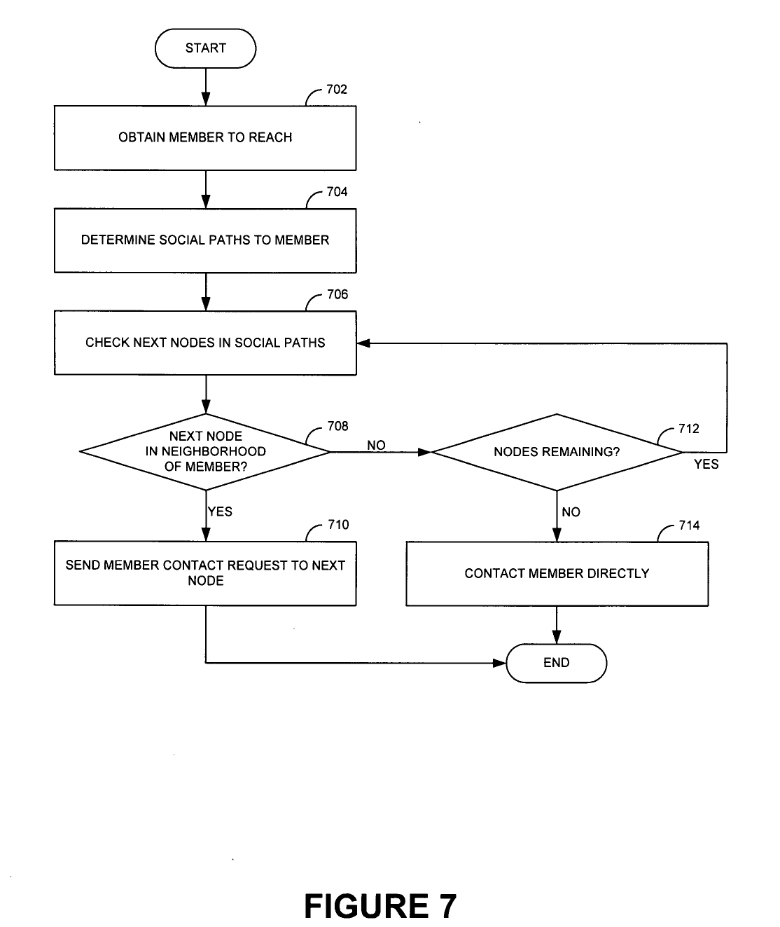

FIG. 7 is a flow chart for contacting a target member (e.g., the member 106 of FIG. 1) using at least one node, according to one embodiment. In operation 702, a location of the member 106 sought (e.g., the target member) is obtained from the geo-spatial repository 116. The geo-spatial repository 116 may contain the location data associated with the target member 106. The location may be represented using geo-positioning coordinates (e.g., latitude and a longitude. In operation 704, social paths to the target member 106 are determined. Multiple social paths may be formed between the first member 106 and the target member 106. Furthermore, each social path may include one or more nodes and/or social links between the first member 106 and the target member 106. In operation 706, nodes in the social paths are checked to determine the closest node existing in neighborhood of the target member 106. The neighborhood may correspond to a certain geographic area (e.g., location) around the residence of the target member 106.

In operation 708, it is determined whether the next node is in the neighborhood of the target member 106 or not. For example, each node in the set of nodes is selected and a geographic proximity of each node with the target member 106 is determined. The geographic proximity may be associated with the locations of the node and the target member 106 (e.g., using the geo-spatial relationship analysis module 114 of FIG. 1). If any of the nodes is in the neighborhood of the target member 106, a member contact request may be sent to the node in operation 710.

If the selected node is not in the neighborhood of the member 106, then operation 712 is performed. In operation 712, it is determined whether there are nodes remaining in any of the social paths or not. If any nodes are remaining in the social paths, then the above operations may be repeated until a proximate node is obtained. In operation 714, the target member 106 is contacted directly by the member 106 if the proximate node located in the neighborhood of the target member 106 is not obtained.

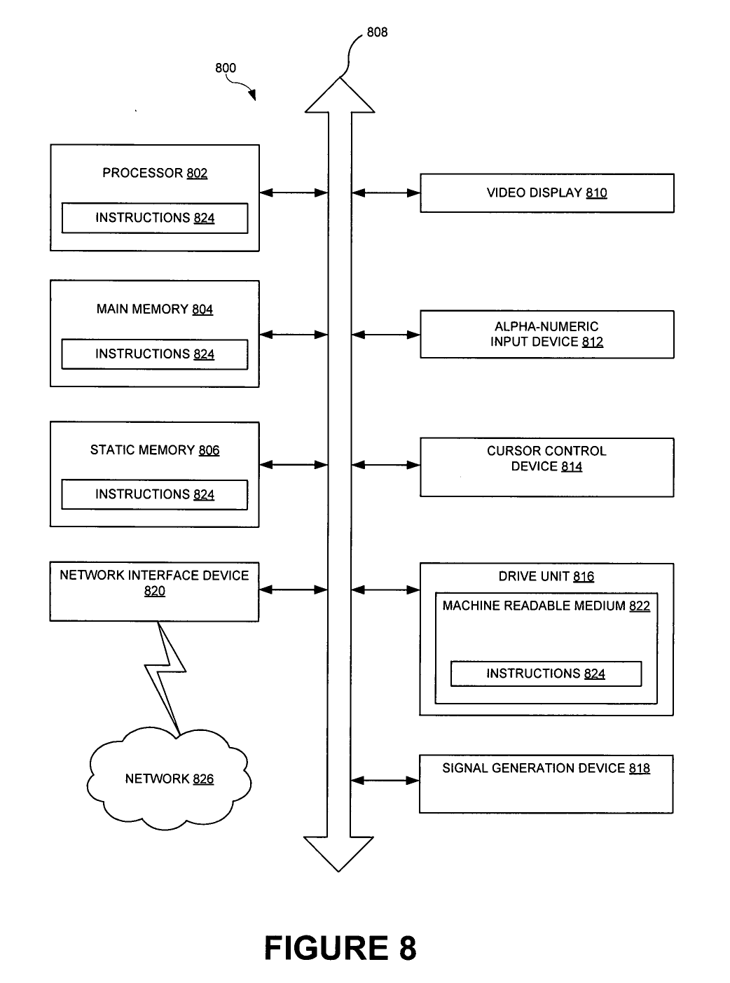

FIG. 8 is a diagrammatic system view 800 of a data processing system in which any of the embodiments disclosed herein may be performed, according to one embodiment. Particularly, the system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein are performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of a computer system. The static memory 806 may be a hard drive, a flash drive, and/or other memory information associated with the data processing system. The bus 808 may be an interconnection between various circuits and/or structures of the data processing system.

The video display 810 may provide graphical representation of information on the data processing system. The alpha-numeric input device 812 may be a keypad, a keyboard and/or any other input device of text (e.g., a special device to aid the physically handicapped). The cursor control device 814 may be a pointing device such as a mouse. The drive unit 816 may be the hard drive, a storage system, and/or other longer term storage subsystem. The signal generation device 818 may be a bios and/or a functional operating system of the data processing system.

The network interface device 820 may be a device that may perform interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one/or more operations disclosed herein.

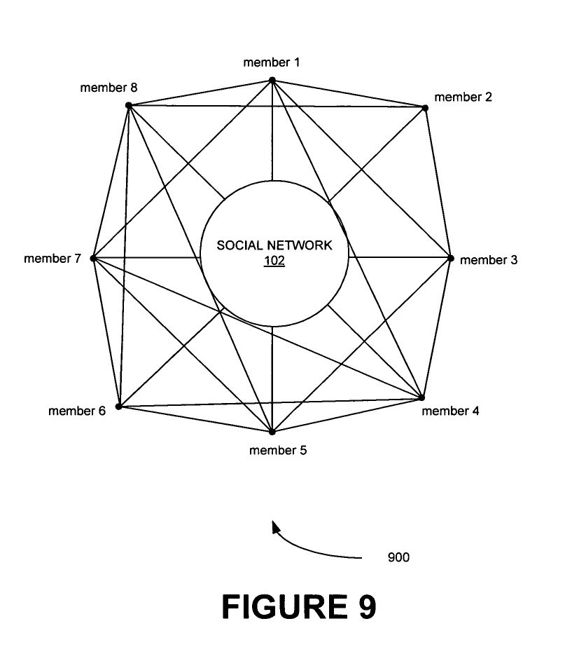

FIG. 9 is a network diagram 900 of the social network 102 of FIG. 1, according to one embodiment. In the example embodiment illustrated in FIG. 9, the network diagram 900 displays members (e.g., the members 1-8 of FIG. 9, the members 106A-N of FIG. 1) of a community (e.g., the community 104 of FIG. 1) connected through the social network 102. The network diagram 900 illustrates associations between the members 1-8 of the community 104. The network diagram 900 displays certain connections through which the associated members 106 (e.g., the members 1-8 of FIG. 9) communicate directly with each other. The network diagram 900 also displays the connections through which certain members 106 communicate with the other members 106 not known to them (e.g., using nodes in the social network 102). As described above, the network diagram 900 may include a number of social links between the members 106, as well as a number of geo-spatial links between the members 106. A member 106 may attempt to reach another member 106 using a combination of social links and geo-spatial links.

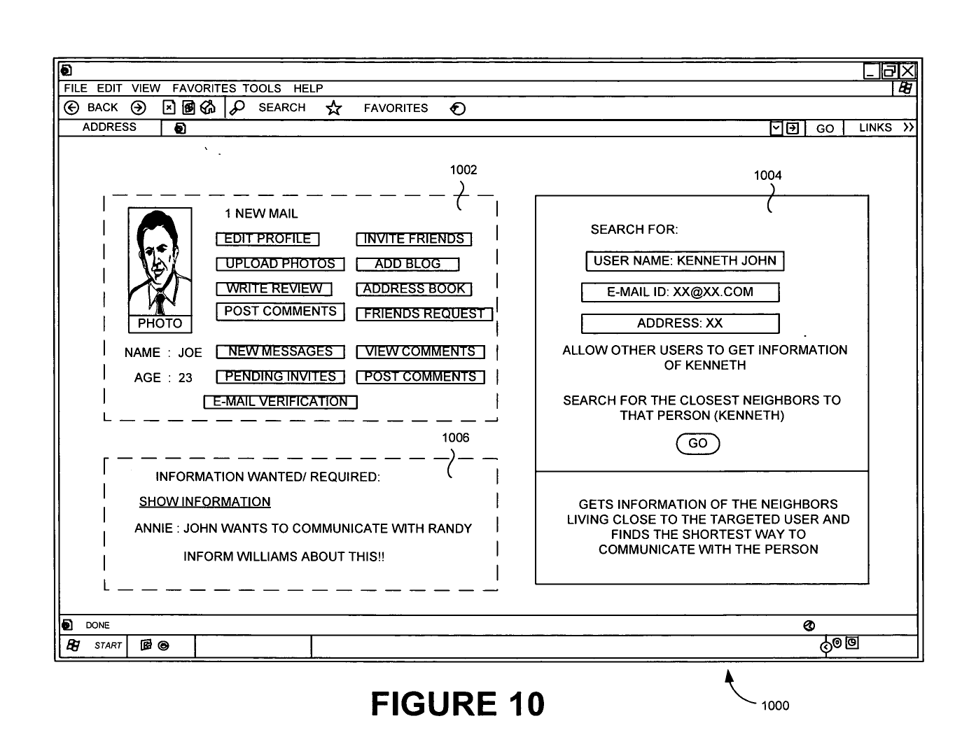

FIG. 10 is a user interface view 1000 of the member search module 304 of FIG. 3, according to one embodiment. Particularly, FIG. 10 illustrates a profile block 1002, a search for option 1004 and an information wanted/required option 1006, according to one embodiment.

The profile block 1002 may display content information (e.g., an address book, a profile, comments, etc.,) associated with a user (e.g., of the social network 102 of FIG. 1). The profile block 1002 may also enable the user to update, modify and/or delete the content information. The search for option 1004 may permit the user to search for the location associated with the member(s) 106 of the community (e.g., the community 104 of FIG. 1) and/or display results based on a search query requested by the user. The information wanted/required option 1006 may display the information required from the user (e.g., submitted by other users).

In the example embodiment illustrated in FIG. 10, the user interface view 1000 displays a user profile (e.g., associated with the member 106 of the social network 102 of FIG. 1). The profile block 1002 displays an edit profile option, an upload photos option, a write review block, a post comments option, a view comments block, an invite friends option, an add blog, an address book, a view new messages option, etc. For example, the user may use the options to submit and/or update changes to the member repository 110. The search for option 1004 may enable the user to search for the members 106 through whom the social paths are formed with the target member 106. In addition, the search for option 1004 may also allow the user to search for the closest neighbors located in the neighborhood of the target member 106.

The user interface view 1000 includes the information wanted/required option 1006, which displays information required and/or requested by other users for the user (e.g., Joe). For example, John may be a few social links away from Randy and may like to communicate with Randy. John may have some type of relationship (e.g., a business relationship, a personal relationship, and/or other ties, etc.) with Annie. As a result, John and Annie may be connected through a social link. Annie may not know Randy but she has knowledge that Joe knows Williams who knows Randy. So Annie may send a contact request to Joe that includes information (e.g., “John wants to communicate with Randy, inform Williams about this”), so that a social link is formed between Annie and Joe.

In addition, the user Joe may contact Randy (e.g., the target member 106) through Williams, conveying the message that John wants to communicate with Randy. Joe may find information about Williams using the search for option 1004 based on name, email, and/or address data associated with Williams. Williams' location may be identified as being in the neighborhood of Randy (e.g., the target member), so that Williams can contact Randy directly on behalf of John (e.g., the first member). Therefore, a social path is formed between John and Randy through the members Annie, the user (e.g., Joe), and Williams, as illustrated in the example embodiment.

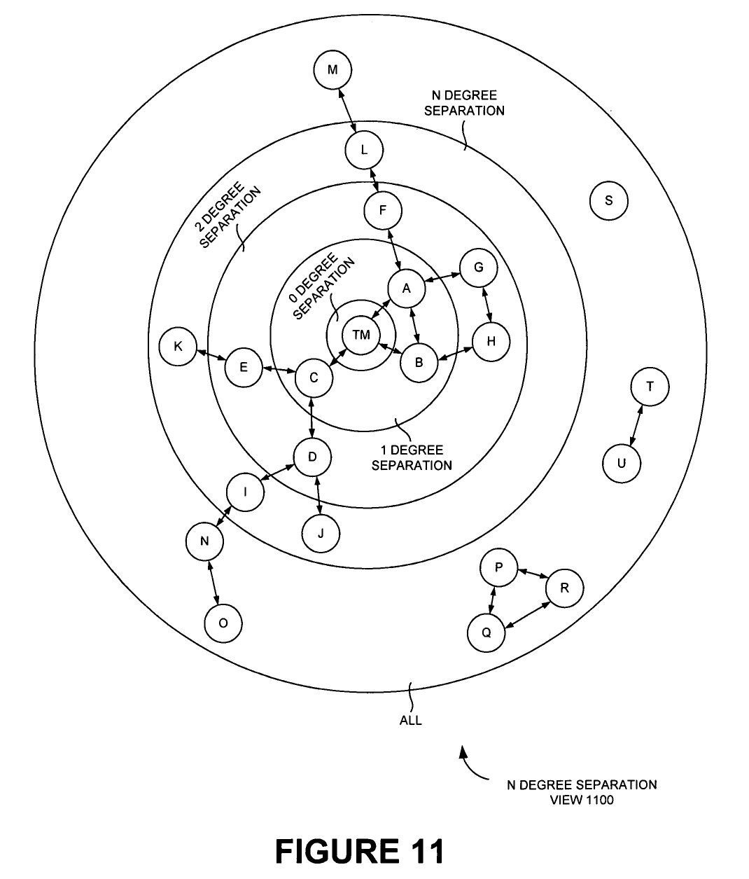

FIG. 11 is an nth degree separation view, according to one embodiment. TM may be a target member 106 of the community (e.g., the community 104 of FIG. 1). A, B, C, D, E, F, G, H, I, J, K, L, M, N, O, P, Q, R, S, T, and/or U may be the other members (e.g., the members 106A-N illustrated in FIG. 1) of the neighborhood network. The members 106A-N of the community 104 may be separated from the target member TM of the neighborhood network by certain degrees of separation. The members A, B and C may be located proximate to the target member TM, so that they can directly communicate with the target member TM.

In addition, the members A, B, C may be deemed to be separated by one degree of separation from the target member TM. Also, the initial member may communicate with the target member TM using the users A, B and/or C based on the geographic proximity between each member and the target member TM. The members D, E, F, G, and H may be connected to the target member TM through no less than one other member and are deemed to be separated by two degree of separation from the target member TM. The members I, J, K, and L may be connected through no less than N−1 other members and are deemed to be separated by N degree of separation from the target member TM. The users M, N, O, may be connected through no less than N other members, thus forming a social path with the target member. The members P, Q, R S, T and U may be the members of the community 104 (e.g., and are not associated with the target member TM and the members of the social path).

A location of the nth degree away member (a person, a business, and/or an organization, the member 106 of FIG. 1, etc.) may be determined, and/or a social path to the nth degree away member may be obtained (e.g., using the social relationship analysis module 112 of FIG. 1). A geo-spatial association between a node (e.g., the target member TM) of the social path and the location may be determined. The target member TM may be contacted using the node of the social path based on the geo-spatial association. As a result, the geo-spatial association may shorten the social path between two members (e.g., members 106A-N in the social network 102 of FIG. 1).

A social link may be established with the nth degree away member using the node (e.g., using the relationship management module 118 of FIG. 1). A global positioning system (GPS) coordinate of the at least one node (e.g., a member of the community) may also be obtained. A geo-spatial index may be generated using the GPS coordinate. Furthermore, a geographic proximity may be displayed on the geo-spatial map (e.g., using the relationship display module 306 of FIG. 3).

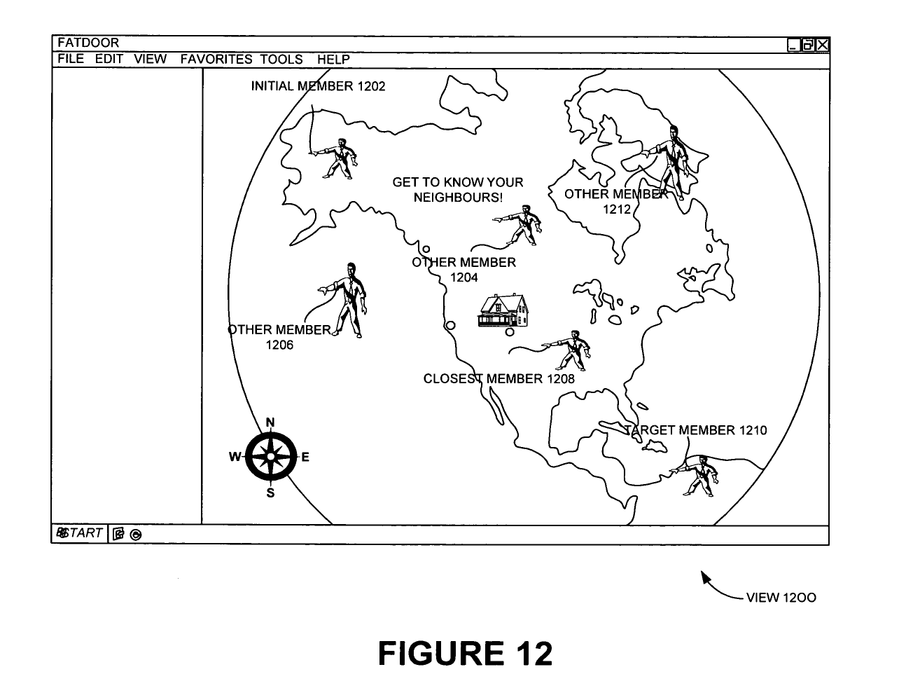

FIG. 12 is a geo-spatial map view 1200 of the members 106A-N of the social network 102, according to one embodiment. Particularly, FIG. 12 illustrates an initial member 1202, other member(s) 1204, 1206, 1208, and 1212, and a target member 1210 on a geo-spatial map, according to one embodiment.

The initial member 1202 may be a member of the social community (e.g., the community 104 of FIG. 1) who wants to communicate with the target member 1210 (e.g., the target member TM of FIG. 11). The member(s) 1204, 1206, 1208 and 1212 may be intermediate members through which social paths are formed between the initial 1202 member and the target member 1210 based on the geographic association between the members. In addition, the member 1208 may be located geographically proximate to the target member 1210.

In the example embodiment illustrated in FIG. 12, the geo-spatial map view 1200 may display a satellite view of a physical world showing the locations associated with the members (e.g., the members 106A-N illustrated in FIG. 1). A member of a global neighborhood environment (e.g., the community 104, the social network 102 of FIG. 1, etc.) may explore the geo-spatial map view 1200 to locate a geographical location of a target member 106 and the other members (e.g., other members 106A-N illustrated in FIG. 1). The member 106 (e.g., a user of the social network 102) may navigate, zoom, explore and/or quickly find particular geographical locations of target members 106. This may help the member 106 to read the map and/or plot the route (e.g., the social path and/or the shortest path) between the initial member 106 and the target member 106 (e.g., connected through at least one node on the geo-spatial map).

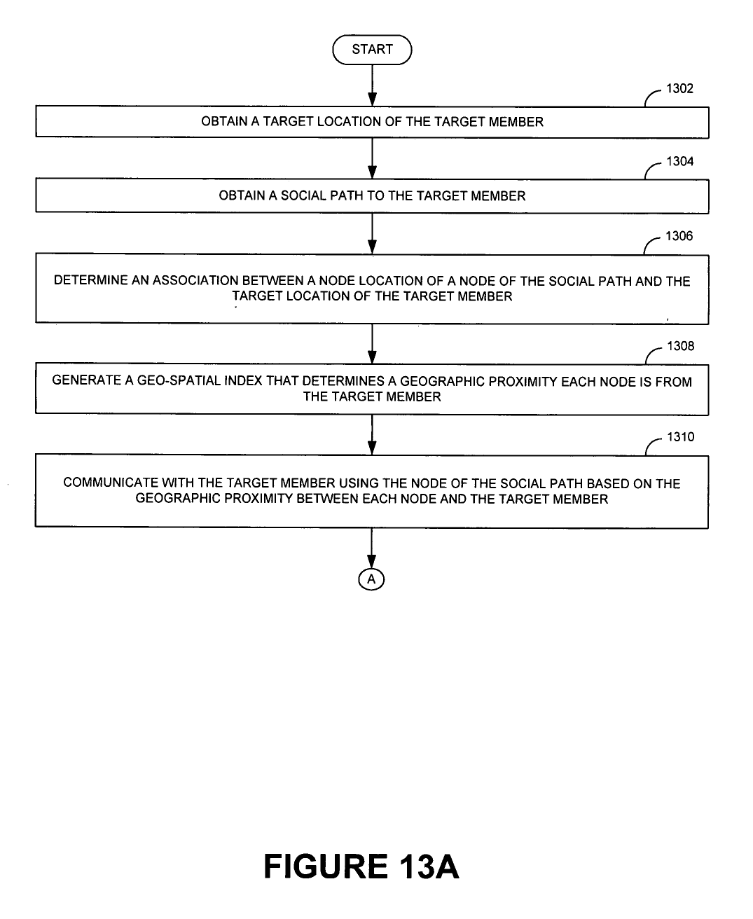

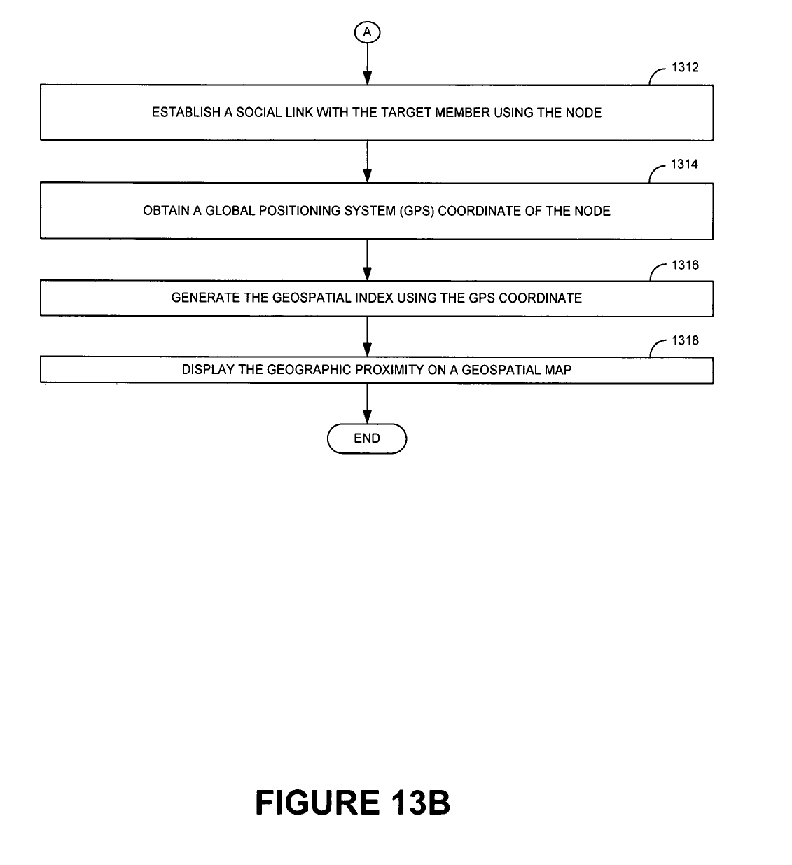

FIG. 13A is a process flow of contacting a target member of a community, according to one embodiment. In operation 1302, a target location of the target member (e.g., the member 106 of FIG. 1) may be obtained (e.g., using the geo-spatial relationship analysis module 114 of FIG. 1). In operation 1304, a social path to the target member 106 may be obtained (e.g., using the social relationship analysis module 112 of FIG. 1). In operation 1306, an association between a node location of a node of the social path and the target location of the target member 106 may be determined (e.g., using the relationship management module 118 of FIG. 1). In operation 1308, a geo-spatial index that determines a geographic proximity each node is from the target member 106 may be generated (e.g., as illustrated in FIG. 2). In operation 1310, the target member 106 may be communicated with using the at least one node of the social path based on the geographic proximity between each node and the target member 106.

FIG. 13B is a continuation of the process flow of FIG. 13A, showing additional processes, according to one embodiment. In operation 1312, a social link may be established with the target member (e.g., the member 106 of FIG. 1) using the node. In operation 1314, a global positioning system (e.g., GPS) coordinate of the node may be obtained. In operation 1316, the geo-spatial index may be generated using the GPS coordinate (e.g., using the geo-spatial relationship analysis module 114 of FIG. 1). In operation 1318, the geographic proximity may be displayed on a geo-spatial map (e.g., as illustrated in FIG. 12).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and/or electrical circuits (e.g., application specific integrated (ASIC) circuitry, Digital Signal Processor (DSP) circuitry, etc.).

For example, the member management module 108, the social relationship analysis module 112, the geo-spatial relationship analysis module 114, the relationship management module 118, the user update module 302, the member search module 304, the relationship display module 306 and the other modules of FIGS. 1-13B may be enabled using a member management circuit, a social relationship analysis circuit, a geo-spatial relationship analysis circuit, a relationship management circuit, a user update circuit, a member search circuit, a relationship display circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of contacting a target member of a community, comprising:
obtaining a target location of the target member;
obtaining a social path to the target member;
determining an association between a node location of at least one node of the social path and the target location of the target member;
generating a geo-spatial index that determines a geographic proximity each node is, from the target member; and
communicating with the target member using the at least one node of the social path based on the geographic proximity between each node and the target member.

2. The method of claim 1, further comprising:
establishing a social link with the target member using the at least one node.

3. The method of claim 1, further comprising:
obtaining a global positioning system (GPS) coordinate of the at least one node; and
generating the geo-spatial index using the GPS coordinate.

4. The method of claim 1, further comprising:
displaying the geographic proximity on a geo-spatial map.

5. The method of claim 1, wherein the geographic proximity is associated with a location of the target member.

6. The method of claim 1, wherein the at least one node comprises a member of the community.

7. The method of claim 1, wherein the target member is at least one selected from a group consisting of a person, a business, and an organization.

8. A social network, comprising:
a geo-spatial repository comprising a plurality of locations;
a member repository comprising a plurality of members;
a social relationship analysis module configured to determine a social path between a first of the plurality of members and a second of the plurality of members, wherein the social path comprises a plurality of nodes from the member repository and a plurality of links between the plurality of nodes; and
a geo-spatial relationship analysis module configured to determine a geo-spatial link between one of the plurality of nodes and the second of the plurality of members,
wherein the geo-spatial link comprises a proximity between a first of the plurality of locations associated with the one of the plurality of nodes and a second of the plurality of locations associated with the second of the plurality of members.

9. The social network of claim 8, further comprising:
a relationship management module configured to determine a shortest path between the first of the plurality of members and the second of the plurality of members,
wherein the shortest path is determined using the social path and the geo-spatial link.

10. The social network of claim 9, wherein the relationship management module is further configured to establish a social link between the first of the plurality of members and the second of the plurality of members.

11. The social network of claim 8, further comprising:
a member management module configured to obtain member data associated with each of the plurality of members,
wherein the member data comprises a location.

12. The social network of claim 11, wherein the location is obtained using a global positioning system (GPS).

13. The social network of claim 8, further comprising:
a user interface, comprising:
a user update module configured to obtain changes to the member repository;
a member search module configured to obtain a search result for the second of the plurality of members based on a query by the first of the plurality of members;
a relationship display module configured to display the plurality of links and the geo-spatial link; and
a geo-spatial tracker configured to display and update the geo-spatial link on a geo-spatial map.

14. The social network of claim 8, wherein each of the plurality of members comprises at least one selected from a group consisting of a person, a business, and an organization.

15. A computer readable medium containing software instructions embodied therein for causing a computer system to perform a method of contacting a nth degree away member of a community, the method comprising:
determining a location of the nth degree away member;
obtaining a social path to the nth degree away member;
determining a geo-spatial association between a node of the social path and the location; and
contacting the member using the node of the social path based on the geo-spatial association.

16. The computer readable medium of claim 15, the method further comprising:
establishing a social link with the nth degree away member using the node.

17. The computer readable medium of claim 15, the method further comprising:
obtaining a global positioning system (GPS) coordinate of the at least one node; and
generating a geo-spatial index using the GPS coordinate.

18. The computer readable medium of claim 15, further comprising:
displaying a geographic proximity on a geo-spatial map.

19. The computer readable medium of claim 15, wherein the node comprises a member of the community.

20. The computer readable medium of claim 15, wherein the nth degree away member is at least one selected from a group consisting of a person, a business, and an organization.
